(19) United States
(12) Patent Application Publication
(10) Pub. No.: US 2002/0170004 A1
(43) Pub. Date: Nov. 14, 2002

(54) Storage area network monitor device and networked monitor system

(75) Inventors: George Robert Parrett, Trabuco Canyon, CA (US); James David Fainer, Silverado, CA (US)

Correspondence Address: HOGAN & HARTSON L.L.P., 500 S. GRAND AVENUE, SUITE 1900, LOS ANGELES, CA, 90071-2611, US

(73) Assignee: SHUGART TECHNOLOGY, INC.

(21) Appl. No.: 09/852,227

(22) Filed: May 8, 2001

(51) Int. Cl. G06F 11/30

(52) U.S. Cl. 714/43

(57) ABSTRACT

A storage area network (SAN) monitor device and a networked configuration for monitoring the SAN. Application in Fibre Channel is described as an example. In the networked configuration, a plurality of Fibre Channel probe devices are inserted into the fabric at desired links, and the probe devices are connected to each other and to a master via a communications network such as an Ethernet. The probe devices operate in a snoop mode to gather information from the Fibre Channel, and transmit gather information via the communications network to the master for further processing or display. The tasks performed by the probe devices include monitoring performance, health and traffic of the fabric; analyzing specific transfers by capturing all the data; generating traffic to test specific links, etc. The probe devices may be programmable devices so that tasks may be dynamically programmed by the master via the communications network. One probe device described herein comprises a Fibre Channel interface and a programmable logic block connected to the Fibre Channel interface. Also described is a probe attachment module that can be attached to an existing switch on the Fibre Channel to monitor a plurality of Fibre Channel devices connected to the switch.

### BACKGROUND OF THE INVENTION

1. Field of the Invention

This invention relates to devices for testing and monitoring storage area networks (SAN), and in particular, to such monitor devices and a networked monitor system.

2. Description of the Related Art

Fibre Channel is a family of standards developed by the American National Standards Institute (ANSI) which defines a high speed communications interface for the transfer of large amounts of data between a variety of hardware systems such as personal computers, workstations, mainframes, supercomputers, storage devices and servers that have Fibre Channel interfaces. Fibre Channel provides a general transport vehicle for Upper Level Protocols (ULPs) such as Intelligent Peripheral Interface (IPI) and Small Computer System Interface (SCSI) command sets, the High-Performance Parallel Interface (HIPPI) data framing, Internet Protocol (IP), IEEE 802.2, Asynchronous Transfer Mode (ATM), and the like. Compared to many other interconnection systems for computer systems such as the SCSI bus, Fibre Channel can support a large number of devices (“nodes” or “links”) with a large distance limit between nodes. Fibre Channel supports a matrix interconnection (a fabric) and a loop topology (Fibre Channel Arbitrated Loop, FCAL). Merging high-speed I/O and networking functionality into one connectivity technology, Fibre Channel provides a solution for high-speed data transfer and has been widely accepted in the computer industry, especially in client/server applications which demand high bandwidth and low latency I/O such as mass storage, medical and scientific imaging, multimedia communication, transaction processing, distributed computing and distributed database processing applications.

Devices connected on the Fibre Channel must be examined from time to time to determine the performance, health and traffic of the Fibre Channel. Current methods for testing, monitoring and analyzing Fibre Channel devices employ dedicated computers, such as PCs, connected to the devices being analyzed. Commands and data are issued from the dedicated computer to the device being analyzed, and data are received and analyzed by the computer.

### SUMMARY OF THE INVENTION

The present invention provides method and apparatus for testing and monitoring a Fibre Channel link or links to determine the overall performance, health and traffic (data flow) of the fabric.

An object of the present invention is to provide a more efficient method and apparatus for testing, monitoring and analyzing the performance of the Fibre Channel.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention provides a networked probe (or monitor) system for a Fibre Channel, the system including a plurality of Fibre Channel probe (or monitor) devices connected to the Fibre Channel and to a communications network, and a master connected to the communications network and communicating with the probe devices. The probe devices transmit information gathered from the Fibre Channel to the master via the communications network. In addition, the probe devices may be programmed by the master via the communications network.

In another aspect, the present invention provides a probe for a Fibre Channel, the probe including a Fibre Channel interface for communicating with the Fibre Channel and a programmable logic block connected to the Fibre Channel interface and a communications network. The programmable logic block is programmed to perform all the monitoring functions of the probe, and may be programmable via software instructions received from the communications network. The probe devices may be portable and can be easily installed and removed from a Fibre Channel link.

In another aspect, the present invention provides a probe attachment module attached to a switch device on the Fibre Channel to monitor a plurality of Fibre Channel devices connected to the switch. A multiplexer is provided in the attachment module to selectively connect one or more of the Fibre Channel devices to a probe contained in the module.

In yet another aspect, the present invention provides a method for monitoring a Fibre Channel. The method includes gathering information about the Fibre Channel using a plurality of probe devices connected to the Fibre Channel, communicating the gathered information to a master via a communications network, and processing the communicated information using the master.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a Fibre Channel topology with probe devices inserted into the fabric according to an embodiment of the present invention.

FIG. 2 shows a Fibre Channel probe device according to an embodiment of the present invention.

FIG. 3 schematically illustrates a Fibre Channel topology with probe attachment modules inserted into the fabric according to an embodiment of the present invention.

FIG. 4 shows a Fibre Channel probe attachment module according to an embodiment of the present invention.

FIG. 5 shows another Fibre Channel probe attachment module according to an embodiment of the present invention.

### DETAILED DESCRIPTION OF THE PREFERRED EMBODIMENTS

The preceding summary and the following detailed description are provided using the Fibre Channel as an example of a storage area network (SAN). The invention is applicable to other types of SANs as well, such as Gigabit Ethernet or Infiniband. The claimed invention is intended to cover all such applications. The implementation details may differ for different types of networks, but such detains are within the purview of those skilled in the relevant art and the invention can be practices based on the description herein and the general knowledge in the art without undue experimentation. The monitor devices described herein may be generally referred to as SAN monitors, or Fibre Channel monitors or Fibre Channel probes when used in the context of a Fibre Channel system. These terms are used interchangeably.

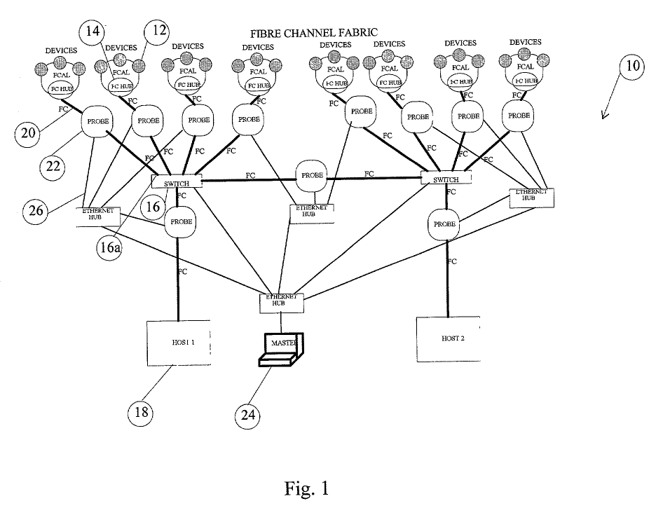

The present invention provides method and apparatus for monitoring and testing Fibre Channel devices (or more generally, SAN devices) to determine the overall performance, health and traffic (data flow) of the fabric. FIG. 1 illustrates a fabric 10 and a networked probe system according to an embodiment of the present invention. Here, the term “fabric” is used to generally refer to any Fibre Channel topology, including a fabric, a loop or a point to point topology. The fabric 10 includes, for example, a plurality of devices 12, Fibre Channel hubs 14, switches 16, and hosts 18 connected by the Fibre Channel 20 (shown as double lines in the figure). A plurality of Fibre Channel probes 22 are inserted into the fabric at various links as desired. The probes 22, as well as one or more masters 24, are connected to a communications network 26 (shown as single lines in the figure) such as an Ethernet. The master 24 may be any type of computer system, such as a PC, workstation, etc. Each Fibre Channel probe 22 is capable of performing one or more monitoring tasks in real time, including but not limited to: (1) Monitoring performance, health and traffic of the fabric; (2) analyzing specific transfers by capturing all the data; and (3) generating traffic to test specific links. The Fibre Channel topology of FIG. 1 is exemplary only; the probes 22 may be used with any Fibre Channel topology.

The probes 22 communicate with each other and with the master 24 using the communications network 26, instead of the Fibre Channel 20. This may be referred to as out-of-band communication. Preferably, the probes 22 operate in an unobtrusive “snoop mode” when gathering data from the Fibre Channel so as to minimize added latency to data transfer on the Fibre Channel. The probes 22 receive data from the Fibre Channel, partially process the data and transmit partially processed data (such as statistical information) to the master 24 via the communications network 26. The master 24 further processes the information and displays the results on a display system to be viewed by a user. The plurality of probes 22, in conjunction with the master 24, are therefore capable of providing a complete picture of the Fibre Channel network in real time.

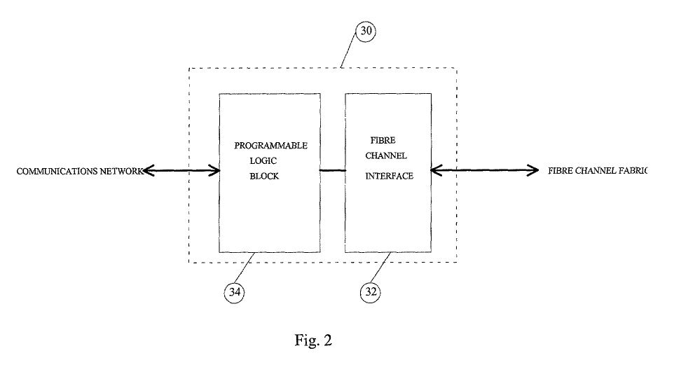

Generally, any suitable Fibre Channel probe devices capable of performing the above-described tasks may be used as the probe 22 in the topology of FIG. 1. One such probe device according to an embodiment of the present invention is shown in FIG. 2. The probe 30 includes a Fibre Channel interface 32 for connecting to and communicating with the Fibre Channel 20, and a programmable logic block 34 adapted to be connected to the communications network 26. Preferably, the probe 30 is a full duplex device capable of communicating with the Fibre Channel in both direction as well as communicating with the communications network in both directions. The Fibre Channel interface 32 is a device generally known in the field. The programmable logic block 34 is programmed to control all the monitoring functions of the probe 30 by issuing commands to, transmitting data to, and/or receiving data from, the Fibre Channel through the interface 32, and communicating with the master or other Fibre Channel probe devices via the communications network 26.

By employing programmable logic block 34, the probe 30 is flexible and can be programmed to performed any desirable monitoring tasks. In one embodiment, the programmable logic block 34 is dynamically configured by the user (such as a tester) through software instructions loaded from the master 24 via the communications network 26. Changes or improvements to the monitoring tasks can be added remotely without removing the probe devices from their attachment points in the fabric. This enables the user to dynamically specify the tasks performed by each probe in the Fibre Channel topology as needed. It also enables new configuration options to be added to the fabric as future needs arise.

In another embodiment, the Fibre Channel interface 32 and the programmable logic block 34 are contained in a housing to form an integral Fibre Channel probe unit. Such a unit may be a portable unit that can be easily installed in or removed from any Fibre Channel link as needed. Thus, a single portable device may be shared among multiple Fibre Channel devices and links, thereby reducing equipment cost. A combination of portable and non-portable probe devices may be used at various links of the fabric and connected to the same communications network.

Although a programmable logic block 34 is employed in the probe 30 shown in FIG. 2, other hardware capable of performing control and data processing functions may be used, such as a hard-wired control logic, a processor or the like.

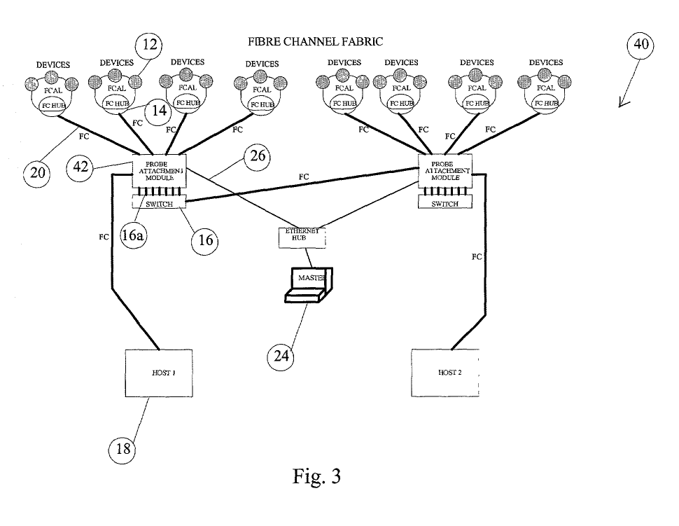

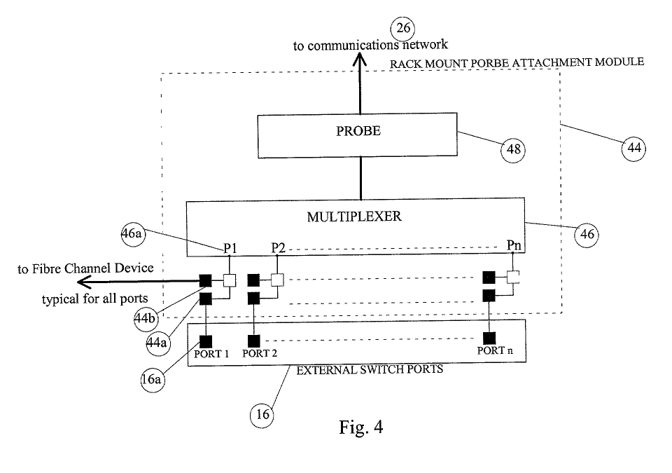

FIGS. 3 and 4 show an attachment module according to another embodiment of the present invention. FIG. 3 schematically illustrates an exemplary Fibre Channel fabric 40, which includes Fibre Channel devices 12, Fibre Channel hubs 14, switches 16, and hosts 18 connected to the Fibre Channel 20. The switch 16 is a known Fibre Channel switching device having a plurality of ports 16a to which a plurality of Fibre Channel devices 12 may be connected (see also FIG. 1). A probe attachment module 42 containing one or more probes is connected to the switch 16 at the ports 16a, as well as to the Fibre Channel devices 12 to be monitored. In addition, the probe attachment module 42 is connected to a communications network 26 such as an Ethernet, to which other Fibre Channel probes and/or probe attachment modules as well as one or more masters 24 are also connected. The probe attachment module 42 is preferably attached to or mounted together with the switch 16.

The probe attachment module 42 performs similar tasks as the probes 22 in the configuration of FIG. 1. These tasks include but are not limited to: (1) Monitoring performance, health and traffic of the fabric; (2) Analyzing specific transfers by capturing all the data; and (3) Generating traffic to test specific links. Similar to the configuration of FIG. 1, the probe attachment module 42 operates in an unobtrusive “snoop mode”. The modules communicate with each other and the master 24 “out of band” using the communications network 26. A combination of probes and probe attachment modules may be used in conjunction with the master to provide a complete picture of the network in real time.

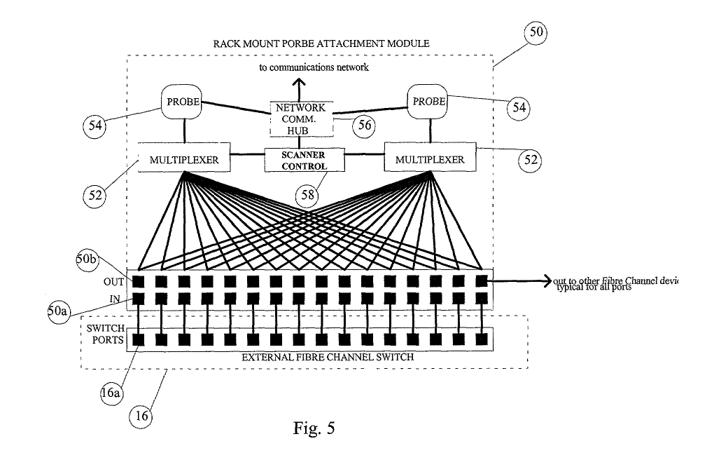

FIG. 4 illustrates the structure of a probe attachment module that can be used in the configuration of FIG. 3. The probe attachment module 44 has a plurality of ports 44a adapted to be connected to the ports 16a of the switch 16, and a plurality of corresponding ports 44b adapted to be connected to Fibre Channel devices to be monitored. Each port 44b corresponds to a port 44a, and the pair of ports 44a and 44b are connected to each other and to a terminal 46a of a multiplexer 46. The multiplexer 46 selectively connects one or more terminals 46a to a Fibre Channel probe 48, which may be a similar device as the probe 30 shown in FIG. 2. Due to this configuration, a Fibre Channel device connected to a port 44b of the probe attachment module is connected to the switch 16 to allow normal performance of the switching function of the switch. In the mean time, the multiplexer 46 allows the probe 48 to be selectively connected to one or more of the Fibre Channel devices to perform the monitoring functions. The multiplexer 46 may be controlled by a scanner control (not shown in FIG. 4; see scanner control 58 shown in FIG. 5) to dynamically scan the ports 44b. Any desired scan patterns may be implemented to control the amount of time spent on each port 44b during a scan. For example, equal time may be allocated to each port, or the probe may be locked in and stay on certain ports. The probe 48, as well as the scanner control if present, is connected to the communication network and may be dynamically programmed to implement desired scan patterns and monitoring tasks.

FIG. 5 illustrates the structure of another probe attachment module that can be used in the configuration of FIG. 3. Similar to the module 44 shown in FIG. 4, the probe attachment module 50 includes a plurality of ports 50a adapted to be connected to the ports 16a of the switch 16, and a plurality of corresponding ports 50b adapted to be connected to the Fibre Channel devices to be monitored. Two multiplexers 52 are provided, each connected to a respective Fibre Channel probe 54, and each port 50b is connected to either or both of the multiplexers. Preferably, the multiplexers 52 are controlled by a scanner control 58. Both the probes 54 and the scanner control 58 are connected to the communications network, preferably via a network communication hub 56. This allows the probes and the scanner control to be dynamically programmed to implement desired scan patterns and monitoring tasks. Although two multiplexers and two probes are illustrated in FIG. 5, any suitable number of multiplexers and probes may be provided. The probe attachment modules shown in FIGS. 3 to 5 facilitate reduction of cost as the probes in the probe attachment module are shared by a plurality of Fibre Channel devices.

In the structure shown in FIGS. 4 and 5, the plurality of ports 44a and 44b (or 50a and 50b) facilitate easy mounting or attachment of the module 44 (50) to an existing switch 16 in the fabric. When installing the probe attachment module 44 (50), each port 44a (50a) is connected to a port 16a of the switch 16, and a Fibre Channel device that would be connected to a port 16a of the switch 16 is now connected to a port 44b (50b) corresponding to the port 44a. Thus, the probe attachment module 42 is easily attached to or mounted together with the switch 16. Alternatively, probe attachment module structures may be employed that do not use the pairs or ports 44a/44b (50a/50b), so long as each Fibre Channel device to be monitored is connected to a terminal of the multiplexer 46 (52). The suitable connection configuration depends on the type of Fibre Channel device that the probe attachment module 44 (50) is attached to. Although a switch 16 is used as an example in the embodiments of FIGS. 3 to 5, the probe attachment module may be attached to other Fibre Channel devices. The probe attachment module may also be used in a stand-alone configuration and not be attached to any existing Fibre Channel devices. While an existing device such as a switch provides a convenient attachment point for the probe attachment module, the monitoring functions of the module do not depend in any way on the device it is attached to.

It will be apparent to those skilled in the art that various modifications and variations can be made in the Fibre Channel probe device or module and the networked probe system of the present invention without departing from the spirit or scope of the inventions. For example, the invention is applicable to other types of storage area networks than Fibre Channel. As will be recognized by those skilled in the art, suitable changes would be necessary to apply the invention to other types of SANs. For example, the Fibre Channel interface would be replaced by other suitable SAN interface devices. Thus, it is intended that the present invention cover modifications and variations of this invention that come within the scope of the appended claims and their equivalents.

What is claimed is:

1. A networked monitor system for a storage area network (SAN), comprising:
a plurality of SAN monitor devices each being connected to the SAN and to a communications network, each monitor device being operable to issue commands to, transmit data to, and/or receive data from the SAN; and
a master connected to the communications network and communicating with the monitor devices.

2. The networked monitor system of claim 1, wherein the monitor devices transmit information gathered from the SAN to the master via the communications network.

3. The networked monitor system of claim 1, wherein at least some of the monitor devices are programmable, and wherein the master programs the programmable monitor devices by transmitting software instructions to the monitor devices via the communications network.

4. The networked monitor system of claim 1, wherein at least some of the monitor devices are each housed in a housing and is removeably connected to the SAN.

5. The networked monitor system of claim 1, wherein at least some of the monitor devices are attachment modules each attached to an existing device on the SAN.

6. A monitor for a storage area network (SAN), comprising:
an SAN interface for communicating with the SAN; and
a programmable logic block connected to the SAN interface and adapted to be connected to a communications network.

7. The monitor of claim 6, wherein the programmable logic block is programmed to issue commands to, transmit data to, and/or receive data from the SAN through the SAN interface.

8. The monitor of claim 7, wherein the programmable logic block is programmed to transmit information gathered from the SAN to the communications network.

9. The monitor of claim 6, wherein the programmable logic block is programmable by software instruction received via the communications network.

10. The monitor of claim 6, further comprising a housing, wherein the SAN interface and the programmable logic block are contained within the housing.

11. A monitor attachment module for a storage area network (SAN), the SAN including a plurality of SAN devices to be monitored and a switch having a plurality of ports for connecting to SAN devices, the monitor attachment module comprising:
a plurality of first ports each adapted to be connected to a port of the switch;
a plurality of second ports each adapted to be connected to a SAN device, each second port being connected to a corresponding first port;
at least one SAN monitor adapted to be connected to a communications network; and
at least one multiplexer, each multiplexer being connected to a corresponding monitor for selectively connecting the monitor to one or more second ports.

12. The monitor attachment module of claim 11, further comprising a scan control device connected to the at least one multiplexer for controlling a connection pattern between the monitor and the plurality of second ports.

13. The monitor attachment module of claim 12, wherein the scan control device is adapted to be connected to the communications network.

14. The monitor attachment module of claim 13, further comprising a network communications hub for connecting the monitor and the scan control device to the communications network.

15. The monitor attachment module of claim 13, wherein the monitor and the scan control device are programmable by software instruction received via the communications network.

16. The monitor attachment module of claim 11, comprising:
a plurality of SAN monitor; and
a plurality of multiplexers each corresponding to a monitor for selectively connecting the monitor to one or more second ports.

17. A method of monitoring a storage area network (SAN), comprising:
gathering information about the SAN using a plurality of monitor devices connected to the SAN;
communicating the gathered information to a master via a communications network; and
processing the communicated information using the master.

18. The method of claim 17, further comprising programming the monitor devices by transmitting software instruction from the master to the monitor devices via the communications network.
